(19) United States
(12) Patent Application Publication
(10) Pub. No.: US 2026/0316475 A1
(43) Pub. Date: Oct. 15, 2026

(54) Manufacturing Method Of Transfer Medium And Transfer Recording Method

(71) Applicant: SEIKO EPSON CORPORATION, Tokyo (JP)

(72) Inventors: Kunihiro FUJITA, Shiojiri (JP); Takayoshi KAGATA, Shiojiri (JP); Seiichi MATSUSHIMA, Matsumoto (JP); Kazuto AOKI, Shiojiri (JP)

(21) Appl. No.: 19/465,075

(22) Filed: Jan. 30, 2026

(30) Foreign Application Priority Data
Jan. 31, 2025 (JP) 2025-015698

(51) Int. Cl. B41M 5/035; B41J 2/21

(52) U.S. Cl. CPC B41M 5/0356; B41J 2/211

(57) ABSTRACT

A manufacturing method of a transfer medium according to the embodiment of the present disclosure includes adhering a white ink composition and a glue ink composition to the same region of a base material by an ink jet method in the same scanning to form a mixed layer, in which the white ink composition contains a white color material, a resin, and water, the glue ink composition contains a resin and water, and the resin contained in the white ink composition and the resin contained in the glue ink composition are of different resin types.

The present application is based on, and claims priority from JP Application Serial Number 2025-015698, filed Jan. 31, 2025, the disclosure of which is hereby incorporated by reference herein in its entirety.

### BACKGROUND

### 1. Technical Field

The present disclosure relates to a manufacturing method of a transfer medium and a transfer recording method.

### 2. Related Art

A transfer recording method is known in which a transfer medium at which an image is formed is superimposed on a fabric such as a cloth, and then heated and pressurized to transfer the image to the fabric. In such a method, since the image formed at the transfer medium is advantageous in forming a fine image with high on-demand property, the image is suitably formed by an ink jet method.

The transfer medium can be manufactured by forming an image at a base material such as a peeling sheet and applying an adhesive liquid to the formed image. For example, JP-A-2024-054709 discloses a manufacturing method of a transfer medium, in which ink is ejected onto a peeling sheet and an adhesive liquid is applied by a wet-on-wet method.

However, in the transfer medium in the related art, high-temperature washing fastness of the image transferred and recorded on the fabric is still insufficient.

### SUMMARY

According to an aspect of the present disclosure, there is provided a manufacturing method of a transfer medium, including:
adhering a white ink composition and a glue ink composition to the same region of a base material by an ink jet method in the same scanning to form a mixed layer, in which
the white ink composition contains a white color material, a resin, and water,
the glue ink composition contains a resin and water, and
the resin contained in the white ink composition and the resin contained in the glue ink composition are of different resin types.

According to an aspect of the present disclosure, there is provided a transfer recording method including:
manufacturing a transfer medium by the manufacturing method according to the above-described aspect; and
heating a surface of the transfer medium at which the mixed layer is formed in a state in which the surface faces a fabric to thermally transfer the mixed layer to the fabric.

### BRIEF DESCRIPTION OF THE DRAWINGS

FIG. 1 is a perspective view of a serial printer.

FIG. 2 is a schematic side view of a line printer.

FIG. 3 is a schematic diagram showing an example of nozzle array arrangement of an ink jet head.

FIG. 4 is a flowchart showing an example of the manufacturing method of a transfer medium according to the present embodiment.

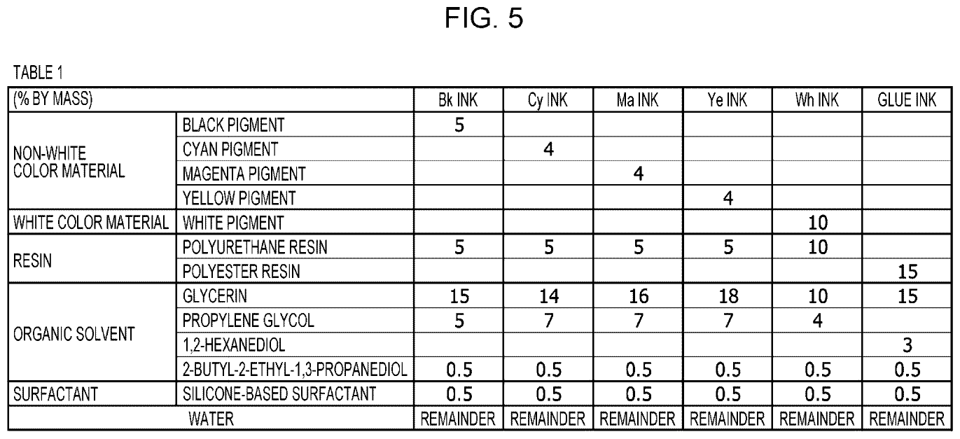

FIG. 5 is Table 1 showing a formulation example of each ink composition.

FIGS. 6A and 6B are Tables 2-1 and 2-2 showing production conditions and evaluation results of the transfer medium according to each example.

### DESCRIPTION OF EMBODIMENTS

Hereinafter, the embodiment of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. Manufacturing Method of Transfer Medium

The manufacturing method of a transfer medium according to the embodiment of the present disclosure includes a step of adhering a white ink composition and a glue ink composition to the same region of a base material by an ink jet method in the same scanning to form a mixed layer, in which the white ink composition contains a white color material, a resin, and water, the glue ink composition contains a resin and water, and the resin contained in the white ink composition and the resin contained in the glue ink composition are of different resin types.

Since the transfer medium in the related art is manufactured by adhering an ink and an adhesive liquid to a base material in a laminated manner, when resins contained in the ink and the adhesive liquid are of different resin types, adhesiveness between an ink layer and an adhesive liquid layer is deteriorated, and thus interface peeling is likely to occur. In particular, interface peeling during washing at a high temperature is significant. Therefore, when the resins contained in the ink and the adhesive liquid are of different resin types, there is a problem with high-temperature washing fastness.

On the other hand, in the manufacturing method of a transfer medium according to the present embodiment, the white ink composition and the glue ink composition are simultaneously adhered to the base material to form a mixed layer of the white ink composition and the glue ink composition (adhesive liquid). As a result, even when the resins contained in the white ink composition and the glue ink composition are of different resin types, the mixed layer of the white ink composition and the glue ink composition is formed, so that the interface peeling is unlikely to occur, and excellent high-temperature washing fastness can be obtained.

Hereinafter, each step included in the manufacturing method of a transfer medium according to the present embodiment will be described.

### 1.1 Mixed Layer Forming Step

The manufacturing method of a transfer medium according to the present embodiment includes a step (mixed layer forming step) of adhering a white ink composition and a glue ink composition to the same region of a base material by an ink jet method in the same scanning to form a mixed layer.

### 1.1.1 Aspect of Application

In the mixed layer forming step included in the manufacturing method of a transfer medium according to the present embodiment, the white ink composition and the glue ink composition are adhered to the same region of the base material by an ink jet method in the same scanning. As described above, by simultaneously adhering the white ink composition and the glue ink composition to the base material, the mixed layer of the white ink composition and the glue ink composition can be formed.

Here, the “scanning” refers to moving an ink jet head relative to a recording region on the base material. In this case, the ink jet head may be moved relative to the base material, or the base material may be moved relative to the ink jet head. Alternatively, both the ink jet head and the base material may be moved so that a relative positional relationship thereof changes.

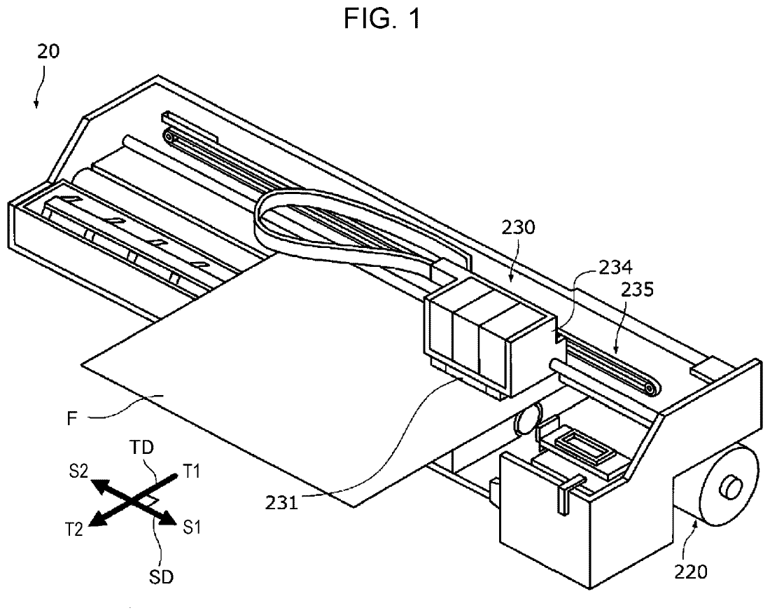

In a serial type ink jet recording device 20 as shown in FIG. 1, for example, the “scanning” is performed by moving a carriage 234 having an ink jet head 231 in a scanning direction SD intersecting a transport direction TD of a base material F.

The ink jet head may be mounted on the carriage, for example. Here, the ink jet head is moved by moving the carriage.

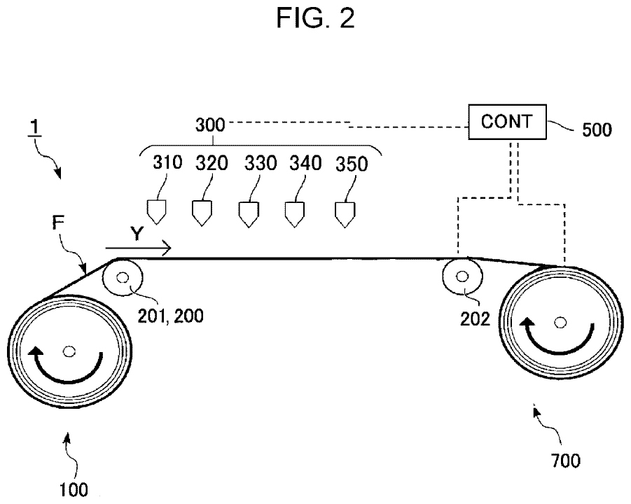

For example, in a line type ink jet recording device 1 shown in FIG. 2, the “scanning” is performed by performing recording while moving a position of the base material F relative to a line head 300 having a length corresponding to a width of the base material F, in a direction intersecting with a direction of the width. In recording of the line type, the ink jet head (line head) does not move and is fixed during the recording, and the recording is performed in a single scanning.

The “length corresponding to the width of the base material” is not limited to a that the width of the base material and the length (width) of the line head completely match, and the length may be a length equal to or more than the length corresponding to the width of the base material, or may be a length corresponding to the width of the base material (recording width) to which the ink or the like is to be ejected.

The number of times of the same scanning to the same region of the base material in the mixed layer forming step may be once or a plurality of times.

When the number of times of the same scanning to the same region of the base material is set to a plurality of times, the ink jet head that ejects the white ink composition and the glue ink composition passes through the same region of the base material a plurality of times. As the number of times of the scanning increases, the white ink composition and the glue ink composition can be adhered to the desired region in a plurality of times (a plurality of passes), the mixed layer is more firmly formed, and thus the interface peeling tends to be more difficult to occur.

More specifically, for example, in FIG. 1, when one transport length of the base material F in the transport direction TD is one-fourth the length in the transport direction TD of the nozzle array arranged in the direction that intersects a scanning direction SD of the ink jet head, the same portion (the same region) is scanned four times with respect to the rectangular scanning region having one length of the transport direction TD in the transport direction TD and extending in the scanning direction SD.

When performing the same scanning a plurality of times, from the viewpoint that the high-temperature washing fastness is more excellent, the number of times is preferably 2 or more, more preferably 3 or more, still more preferably 4 or more, and particularly preferably 6 or more. The upper limit thereof is not limited, but from the viewpoint of productivity, it is preferably 24 or less, more preferably 12 or less, and still more preferably 8 or less.

A time difference in the adhesion of the white ink composition and the glue ink composition to the same region of the base material is preferably within 30 seconds, more preferably within 15 seconds, still more preferably within 5 seconds, even more preferably within 1 second, particularly preferably within 0.5 seconds, and more particularly preferably within 0.1 seconds. When the time difference is within the above-described range, the mixed layer can be more favorably formed, and thus the interface peeling tends to be more difficult to occur.

An adhesion amount of the white ink composition to the base material in the mixed layer forming step is preferably 300 g/m² or less, more preferably 250 g/m² or less, still more preferably 200 g/m² or less, even more preferably 150 g/m² or less, particularly preferably 100 g/m² or less, more particularly preferably 70 g/m² or less, and still more particularly preferably 50 g/m² or less.

In addition, the lower limit of the adhesion amount of the white ink composition to the base material in the mixed layer forming step is not particularly limited, but is preferably 1 g/m² or more, more preferably 10 g/m² or more, still more preferably 20 g/m² or more, and particularly preferably 30 g/m² or more.

An adhesion amount of the glue ink composition to the base material in the mixed layer forming step is preferably 550 g/m² or less, more preferably 400 g/m² or less, still more preferably 250 g/m² or less, even more preferably 150 g/m² or less, particularly preferably 100 g/m² or less, more particularly preferably 70 g/m² or less, and still more particularly preferably 50 g/m² or less.

In addition, the lower limit of the adhesion amount of the glue ink composition to the base material in the mixed layer forming step is not particularly limited, but is preferably 1 g/m² or more, more preferably 10 g/m² or more, still more preferably 20 g/m² or more, and particularly preferably 30 g/m² or more.

The total adhesion amount of the white ink composition and the glue ink composition to the base material in the mixed layer forming step is preferably 550 g/m² or less, more preferably 300 g/m² or less, still more preferably 250 g/m² or less, even more preferably 200 g/m² or less, particularly preferably 150 g/m² or less, and more particularly preferably 100 g/m² or less.

In addition, the lower limit of the total adhesion amount of the white ink composition and the glue ink composition to the base material in the mixed layer forming step is not particularly limited, but is preferably 5 g/m² or more, more preferably 10 g/m² or more, still more preferably 30 g/m² or more, and particularly preferably 50 g/m² or more.

A ratio of the adhesion amount of the glue ink composition to the adhesion amount of the white ink composition in the mixed layer forming step is preferably 0.01 to 100, more preferably 0.1 to 70, still more preferably 0.1 to 50, even more preferably 0.1 to 10, particularly preferably 0.1 to 5, more particularly preferably 0.5 to 3, still more particularly preferably 0.7 to 1.5, and even more particularly preferably 0.8 to 1.2.

### 1.1.2 White Ink Composition

The white ink composition used in the manufacturing method of a transfer medium according to the present embodiment is an ink jet ink composition containing a white color material, a resin, and water.

Hereinafter, each component contained in the white ink composition will be described.

### 1.1.2.1 White Color Material

The white ink composition contains a white color material. Examples of the white color material include a white pigment such as a metal oxide, barium sulfate, and calcium carbonate. In addition, particles having a hollow structure may be used as the white color material, and known particles can be used, as the particles having a hollow structure.

In the present specification, the term “white” when referring to a white ink composition, a white color material, and the like does not mean only completely white, but as long as the color is in a range of being visually recognized as white, the white includes color that is colored with chromatic color or achromatic color, or color having glossiness. In addition, the name of the ink or color material includes those that suggest that the ink or color material is white and those that are named and sold.

More quantitatively, the “white” in a recorded matter may include not only a color in which L* is 100, but also a color in which L* is 60 or more and 100 or less and a* and b* each are ±10 or less, in CIELAB, for example. In addition, a color other than “white” is referred to as “non-white”.

Examples of the white pigment include C. I. Pigment White 1 that is basic lead carbonate, C. I. Pigment White 4 made of zinc oxide, C. I. Pigment White 5 made of a mixture of zinc sulfide and barium sulfate, C. I. Pigment White 6 made of titanium dioxide, C. I. Pigment White 6:1 made of titanium dioxide containing other metal oxides, C. I. Pigment White 7 made of zinc sulfide, C. I. Pigment White 18 made of calcium carbonate, C. I. Pigment White 19 made of clay, C. I. Pigment White 20 made of mica titanium, C. I. Pigment White 21 made of barium sulfate, C. I. Pigment White 22 made of gypsum, C. I. Pigment White 26 made of magnesium oxide and silicon dioxide, C. I. Pigment White 27 made of silicon dioxide, C. I. Pigment White 28 made of anhydrous calcium silicate, and the like.

As the white color material, titanium dioxide is preferably used from the viewpoint of favorable whiteness and washing fastness among those as exemplified above. The white color material may be used alone or in combination of two or more thereof.

An average particle diameter of the white color material is preferably 100 nm or more and 500 nm or less, more preferably 50 nm or more and 450 nm or less, and still more preferably 200 nm or more and 400 nm or less. By setting the average particle diameter of the white color material in this range, there is a tendency that ejection stability from an ink jet head can be ensured. In addition, there is a tendency that the masking properties can be improved. In the present specification, the “average particle diameter” refers to a volume-based particle size distribution that is a particle diameter at 50% by volume cumulative distribution, unless otherwise specified. The average particle diameter is measured by a dynamic light scattering method or a laser diffraction light method described in JIS Z 8825. Specifically, a particle size analyzer (for example, “Microtrac UPA” manufactured by Nikkiso Co., Ltd.) using the dynamic light scattering method as a measurement principle can be used.

The white color material may be dispersed with a dispersant before use. In addition, a surface of the white color material may be oxidized or sulfonated by ozone, hypochlorous acid, fuming sulfuric acid, or the like to be dispersed and used as a self-dispersing type agent.

The dispersant has a function of dispersing the color material in the ink. The dispersant may be water-soluble, but is preferably not completely water-soluble because a part or all of the dispersant is bonded or adsorbed to the color material, so that hydrophilicity of the surface of the color material is increased to be dispersed.

The dispersant is preferably a polymer compound. Examples thereof include acrylic resins such as poly(meth)acrylic acid, a (meth)acrylic acid-acrylonitrile copolymer, a (meth)acrylic acid-(meth)acrylate copolymer, a vinyl acetate-(meth)acrylate copolymer, a vinyl acetate-(meth)acrylic acid copolymer, a vinylnaphthalene-(meth)acrylic acid copolymer, a styrene-(meth)acrylic acid copolymer, a styrene-(meth)acrylic acid-(meth)acrylate copolymer, a styrene-α-methylstyrene-(meth)acrylic acid copolymer, and a styrene-α-methylstyrene-(meth)acrylic acid-(meth)acrylate copolymer, and salts thereof.

In addition, examples of the dispersant also include maleic acid-based resins such as a styrene-maleic acid copolymer, a styrene-maleic anhydride copolymer, a vinylnaphthalene-maleic acid copolymer, and a vinyl acetate-maleate copolymer, and salts thereof; urethane-based resins having or not having a crosslinked structure and salts thereof; polyvinyl alcohols; and a vinyl acetate-crotonic acid copolymer and a salt thereof.

The acrylic resin may include not only a polymer of an acrylic monomer as described above, but also a copolymer of an acrylic monomer and another monomer. For example, an acrylic vinyl resin of a copolymer with a vinyl-based monomer as another monomer is also referred to as the acrylic resin. In addition, the acrylic resin also includes, for example, a copolymer of a styrene-based monomer and an acrylic monomer among the above-described styrene-based resins. Furthermore, the acrylic resin also includes a salt and an esterified product thereof.

Examples of a commercially available product of the dispersant include X-200, X-1, X-205, X-220, and X-228 (manufactured by Seiko PMC Corporation); Nopcosperse (registered trademark) 6100 and 6110 (manufactured by San Nopco Ltd.); JONCRYL 67, 586, 611, 678, 680, 682, and 819 (manufactured by BASF); DISPERBYK-190 (manufactured by BYK Chemie Japan); and N-EA137, N-EA157, N-EA167, N-EA177, N-EA197D, N-EA207D, and E-EN10 (manufactured by DKS Co., Ltd.).

Examples of a commercially available product of the acrylic dispersant include BYK-187, BYK-190, BYK-191, BYK-194N, and BYK-199 (manufactured by BYK Chemie Japan); and Aron A-210, A6114, AS-1100, AS-1800, A-30SL, A-7250, and CL-2 (manufactured by Toagosei Co., Ltd.).

Examples of a commercially available product of the urethane-based dispersant include BYK-182, BYK-183, BYK-184, and BYK-185 (manufactured by BYK Chemie Japan); TEGO Disperse 710 (manufactured by Evonik Tego Chemie GmbH); and Borchi (registered trademark) Gen1350 (manufactured by OMG Borschers GmbH).

A content of the dispersant is preferably 0.1% by mass or more and 30% by mass or less, more preferably 0.5% by mass or more and 25% by mass or less, still more preferably 1% by mass or more and 20% by mass or less, and particularly preferably 1.5% by mass or more and 15% by mass or less with respect to 100% by mass of the white ink composition. When the content of the dispersant is 0.1% by mass or more, dispersion stability of the white color material tends to be ensured. In addition, when the content of the dispersant is 30% by mass or less, a viscosity of the white ink composition tends to be suppressed to be low. The dispersant may be used alone or in combination of two or more thereof.

In addition, a weight-average molecular weight of the dispersant is preferably 500 or more. By using such a dispersant, the odor is likely to be low, and the dispersion stability of the color material is likely to be further improved.

When the white color material is dispersed by the dispersant, a ratio of the white color material to the dispersant is preferably 10:1 to 1:10, and more preferably 4:1 to 1:3.

A content of the white color material is preferably 1% to 30% by mass, more preferably 2% to 25% by mass, still more preferably 4% to 20% by mass, particularly preferably 6% to 15% by mass, and more particularly preferably 8% to 12% by mass with respect to the total amount of the white ink composition. When the content of the white color material is within the above-described range, color development property (whiteness) tends to be more favorable.

### 1.1.2.2 Resin

The white ink composition contains a resin. The resin has a function as a so-called fixing resin for improving adhesiveness of the ink adhered to the base material. The resin is preferably in an emulsion form (resin particles), but may be a powder property.

Examples of the resin include resin types such as a urethane resin, a polyester resin, an acrylic resin, an olefin resin, a fluorene resin, a rosin-modified resin, a terpene resin, an amide resin, an epoxy resin, and a vinyl chloride resin.

The urethane resin is a general term for a resin having a urethane bond. For the urethane resin, a polyether-type urethane resin including an ether bond in the main chain, a ester-type urethane resin including an ester bond in the main chain, and a carbonate-type urethane resin including a carbonate bond in the main chain, in addition to a urethane bond, and the like may be used.

The urethane resin may be a commercially available product, and examples thereof include SUPERFLEX 460, 460s, 840, and E-4000 (product name, manufactured by DKS Co., Ltd.); RESAMINE D-1060, D-2020, D-4080, D-4200, D-6300, and D-6455 (product name, manufactured by Dainichiseika Color & Chemicals Mfg.); TAKELAC WS-5100, WS-6021, W-512-A-6, and W-6110 (product name, manufactured by Mitsui Chemicals Polyurethanes); SANCURE 2710 (product name, manufactured by LUBRIZOL); and PERMARIN UA-150 (product name, manufactured by Sanyo Chemical Industries).

The polyester resin has a constitutional unit derived from a polycarboxylic acid such as terephthalic acid, isophthalic acid, and orthophthalic acid, and a constitutional unit derived from a polyhydric alcohol such as ethylene glycol, 1,2-propylene glycol, and 1,3-propylene glycol, and is obtained by a known condensation reaction between the polycarboxylic acid and the polyvalent alcohol.

The polyester resin may be a commercially available product. Examples of the commercially available product of the polyester resin include Elitel (registered trademark) KA-5034, KA-5071S, KA-1449, KA-0134, KA-3556, KA-6137, KZA-6034, KT-8803, KT-8701, KT-9204, KT-8904, KT-0507, and KT-9511 (all product names) of Unitika Ltd.; PLAS COAT (registered trademark) Z-221, Z-446, Z-561, Z-565, RZ-570, Z-592, Z-687, Z-690, Z-730, Z-760, Z-880, RZ-105, RZ-570, and RZ-760 (all product names) of GOO CHEMICAL CO., LTD.; and VYLONAL (registered trademark) MD-1200, MD-1500, and MD-2000 (all product names) of TOYOBO CO., LTD. These may be used alone or in combination of two or more kinds thereof.

The acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof also include an acrylic-vinyl resin that is a copolymer of an acryl monomer and a vinyl monomer. In addition, examples of the vinyl monomer include styrene. As the acrylic monomer, acrylamide, acrylonitrile, or the like can also be used.

A commercially available product of a resin emulsion using the acrylic resin as a raw material may be used, and for example, a product selected from FK-854 (product name, manufactured by CHUORIKA KOUGYO Co., Ltd.), Mowinyl 952B and 718A (product names, manufactured by The Nippon Synthetic Chemical Industry Co., Ltd.), and Nipol LX852 and LX874 (product names, manufactured by Zeon Corporation) may be used.

In the present specification, the acrylic resin may be a styrene-acrylic resin described later. In addition, in the present specification, the notation of “(meth)acrylic” means acrylic or methacrylic.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylic ester copolymer, a styrene-α-methylstyrene-acrylic acid copolymer, and a styrene-α-methylstyrene-acrylic ester copolymer. A commercially available product of the styrene-acrylic resin may be used, and for example, JONCRYL 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (product names, manufactured by BASF), Mowinyl 966A and 975N (product names, manufactured by The Nippon Synthetic Chemical Industry Co., Ltd.), VINYBLAN 2586 (manufactured by Nissin Chemical Industry Co., Ltd.), and the like may be used.

The olefin resin is a polymer having, in a structural skeleton, olefins such as ethylene, propylene, and butylene, and known olefin resins can be appropriately selected for use. As the olefin resin, a commercially available product can be used, and for example, ARROWBASE CB-1200 and CD-1200 (product names, manufactured by Unitika Ltd.) and the like may be used.

The fluorene resin is a general term for a resin having a fluorene skeleton. Examples of the fluorene resin include a fluorene-based polyester resin, a fluorene-based polyurethane resin, a fluorene-based polyimide resin, a fluorene-based polycarbonate resin, a fluorene-based acrylic resin, and a fluorene-based epoxy resin.

The rosin-modified resin is a general term for a resin derived from rosin. Examples of the rosin-modified resin include a rosin-modified phenol resin, a maleic acid-modified rosin resin, and a rosin ester.

The terpene resin refers to a resin obtained by cationically polymerizing a monomer including, for example, α-pinene, β-pinene, and dipentene as main components, using isoprene (C₅H₈) as a basic unit.

The amide resin is a resin in which a main chain is composed of repeated amide bonds. The amide resin is not particularly limited, and examples thereof include nylon 6, nylon 11, nylon 12, nylon 66, nylon 610, nylon 6T, nylon 6I, nylon M5T, and nylon 612.

The epoxy resin refers to a resin having a reactive epoxy group, and examples thereof include bisphenol-type epoxy such as bisphenol A type and bisphenol F type, novolac-type epoxy such as phenol novolac type and cresol novolac type, epoxy polyol-type epoxy, urethane-modified epoxy, chelate-modified epoxy, and rubber-modified epoxy.

The vinyl chloride resin is not particularly limited, and examples thereof include a copolymer resin of vinyl chloride with one or two or more selected from the group consisting of vinyl acetate, vinylidene chloride, acrylic acid, maleic acid, and vinyl alcohol.

The resin may be used alone or in combination of two or more thereof, but it is preferable that the resin is used alone. The resin is more preferably one selected from a urethane resin, a polyester resin, an acrylic resin, an olefin resin, a fluorene resin, a rosin-modified resin, a terpene resin, an amide resin, an epoxy resin, or a vinyl chloride resin.

A glass transition temperature (Tg) of the resin is preferably −80 °C or higher and 50 °C or lower, more preferably −60 °C or higher and 40 °C or lower, and still more preferably −50 °C or higher and 25 °C or lower. When the glass transition temperature (Tg) of the resin is within the above-described range, there is a tendency that base material followability (texture) and the washing fastness can be excellently balanced. For example, the glass transition temperature is measured in accordance with JIS K7121 (Measurement Methods for Transition Temperatures of Plastics) using a differential scanning calorimeter “DSC 7000” manufactured by Hitachi High-Tech Science Corporation.

In the manufacturing method of a transfer medium according to the present embodiment, the resin contained in the white ink composition and the resin contained in the glue ink composition are of different resin types. When the resins contained in the white ink composition and the glue ink composition are of different resin types, adhesiveness between the ink layer and the adhesive liquid layer is deteriorated, and interface peeling is likely to occur, in particular, interface peeling during washing at a high temperature is significant. On the other hand, with the manufacturing method of a transfer medium according to the present embodiment, the mixed layer of the white ink composition and the glue ink composition is formed, so that excellent high-temperature washing fastness can be obtained.

When at least one of the white ink composition or the glue ink composition contains two or more kinds of resins, the “different resin types” means that at least one kind of the resins is a different resin type. In a composition containing two or more kinds of resins, a content of at least one kind of the resins different from each other is preferably 30% by mass or more, more preferably 50% by mass or more, still more preferably 70% by mass or more, and particularly preferably 90% by mass or more with respect to the total amount of the resins contained in the composition.

The resin type means a type of the resin. Examples of the resin type include an olefin resin (polyethylene (PE), polypropylene (PP), and the like), polystyrene (PS), a vinyl chloride resin (PVC), an ABS resin (ABS), an AS resin (SAN), a polyester resin (polyethylene terephthalate (PET), polybutylene terephthalate (PBT), and unsaturated polyester (UP)), an acrylic resin, polyamide (PA), polycarbonate (PC), polyacetal (POM), polyphenylene ether (PPE), a fluororesin, polyimide (PI), polyethersulfone (PES), polyetherimide (PEI), a urea resin (UF), a melamine resin (MF), an epoxy resin (EP), a silicone resin (SI), polyurethane (PUR), a fluorene resin, a rosin-modified resin, and a terpene resin.

Among these, as the different resin types, a resin type selected from a urethane resin, a polyester resin, an acrylic resin, an olefin resin, a fluorene resin, a rosin-modified resin, a terpene resin, an amide resin, an epoxy resin, or a vinyl chloride resin is preferable; a resin type selected from a urethane resin, a polyester resin, an acrylic resin, or an olefin resin is more preferable; and a resin type selected from a urethane resin or a polyester resin is still more preferable. When the resin contained in the white ink composition and the resin contained in the glue ink composition are different from each other and are selected from such resin types, the interface peeling is likely to occur particularly. On the other hand, with the manufacturing method of a transfer medium according to the present embodiment, even when the resins are different from each other and are selected from such resin types, there is a tendency that excellent high-temperature washing fastness can be obtained.

When the resin contained in the white ink composition and the resin contained in the glue ink composition are of different resin types, it is more preferable that the resin contained in the white ink composition is a urethane resin and the resin contained in the glue ink composition is a polyester resin. The urethane resin has excellent stretchability, but is likely to have deteriorated adhesiveness to the fabric. In addition, the polyester resin has excellent adhesiveness to the fabric, but is likely to have deteriorated stretchability. Therefore, it is preferable that the white ink composition contains a urethane resin and the glue ink composition contains a polyester resin; but in the related art, when the resins contained in the white ink composition and the glue ink composition are of different resin types, the interface peeling is likely to occur, and there is a problem with high-temperature washing fastness. On the other hand, with the manufacturing method of a transfer medium according to the present embodiment, excellent high-temperature washing fastness can be obtained, the urethane resin is contained in the white ink composition to obtain a favorable texture, and the polyester resin is contained in the glue ink composition to obtain a favorable transferability.

A content of the resin is preferably 1% to 30% by mass, more preferably 2% to 25% by mass, still more preferably 4% to 20% by mass, particularly preferably 6% to 15% by mass, and more particularly preferably 8% to 12% by mass with respect to the total amount of the white ink composition. When the content of the resin is within the above-described range, there is a tendency that more excellent washing fastness can be obtained.

### 1.1.2.3 Water

The white ink composition contains water. Examples of the water include pure water such as ion-exchanged water, ultrafiltration water, reverse osmosis water, and distilled water, water having reduced ionic impurities such as ultrapure water, and the like. In addition, when water sterilized by ultraviolet irradiation or addition of hydrogen peroxide or the like is used, the generation of bacteria or fungi can be suppressed when the white ink composition is stored for a long period of time.

A content of the water is preferably 10% by mass or more, more preferably 30% by mass or more, still more preferably 40% by mass or more, and particularly preferably 50% by mass or more with respect to the total amount of the white ink composition. The upper limit of the content of the water is not particularly limited, but is, for example, preferably 90% by mass or less, more preferably 80% by mass or less, and still more preferably 70% by mass or less with respect to the total amount of the white ink composition.

### 1.1.2.4 Organic Solvent

The white ink composition may contain an organic solvent. Examples of the organic solvent include esters, alkylene glycol ethers, cyclic esters, amides, alcohols, and polyhydric alcohols.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, propionate ethylene glycol acetate, butyrate ethylene glycol acetate, butyrate diethylene glycol acetate, propionate diethylene glycol acetate, butyrate diethylene glycol acetate, propionate propylene glycol acetate, butyrate propylene glycol acetate, butyrate dipropylene glycol acetate, and propionate dipropylene glycol acetate.

The alkylene glycol ethers may be alkylene glycol monoethers or diethers, and are preferably alkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like.

Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, N,N-dimethylisobutyrate amide, and the like.

Examples of alcohols include a compound in which one hydrogen atom of alkane is substituted with a hydroxyl group. The alkane preferably has 10 or less carbon atoms, more preferably 6 or less carbon atoms, and still more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxy ethanol, benzyl alcohol, phenoxy propanol, and the like.

Polyhydric alcohols have two or more hydroxyl groups in the molecule. The polyhydric alcohols can be classified into, for example, alkanediols and polyols.

Examples of alkanediols include compounds in which alkane is substituted with two hydroxyl groups. Examples of alkanediols include 1,2-alkanediol, that is a general term for compounds in which hydroxyl groups are substituted at the first and second positions of alkanes, and other alkanediols other than 1,2-alkanediol.

Examples of the 1,2-alkanediol include ethylene glycol, 1,2-propanediol (propylene glycol), 1,2-butanediol (1,2BD), 1,2-pentanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, 2-methyl-2-propyl-1,3-propanediol, and 2-butyl-2-ethyl-1,3-propanediol.

Examples of the polyols include a condensate in which two or more molecules of alkanediols are intermolecularly condensed between hydroxyl groups, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1,2,5-hexanetriol, 1,2,6-hexanetriol, pentaerythritol, polyoxypropylenetriol, and the like.

The organic solvent may be used alone or in combination of two or more thereof.

Regarding the organic solvent, a content of an organic solvent having a standard boiling point of 250 °C or higher is preferably 3.0% by mass or more, more preferably 5.0% by mass or more, and still more preferably 8.0% by mass or more with respect to the total amount of the white ink composition. The upper limit of the content is not particularly limited, but is preferably 20% by mass or less, more preferably 15% by mass or less, and still more preferably 12% by mass or less with respect to the total amount of the white ink composition.

When the content of the organic solvent having a standard boiling point of 250 °C or higher is within the above-described range, the fastness and transferability of the transferred image tend to be further improved.

Examples of the organic solvent having a standard boiling point of 250 °C or higher include glycerin and polyethylene glycol monomethyl ether. The organic solvent having a standard boiling point of 250 °C or higher more preferably has a standard boiling point of 270 °C or higher, and still more preferably has a standard boiling point of 280 °C or higher.

A content of the organic solvent is preferably 5% by mass or more and 50% by mass or less, more preferably 7% by mass or more and 40% by mass or less, still more preferably 10% by mass or more and 35% by mass or less, and particularly preferably 12% by mass or more and 20% by mass or less with respect to the total amount of the white ink composition.

In particular, the total content of the organic solvents contained in the white ink composition is preferably 20% by mass or less with respect to the total amount of the white ink composition. In such a case, since the solvent can be sufficiently volatilized without increasing the heating temperature when drying the white ink composition, there is a tendency that damage to the transfer medium can be reduced.

### 1.1.2.5 Surfactant

The white ink composition may contain a surfactant. The surfactant can be used for reducing a surface tension of the ink and for adjusting and improving, for example, wettability of an ink adhering surface.

As the surfactant, any of a nonionic surfactant, an anionic surfactant, a cationic surfactant, or an amphoteric surfactant can be used, and these surfactants may also be used in combination. In addition, among the surfactants, acetylene glycol-based surfactants, silicone-based surfactants, or fluorine-based surfactants can be preferably used.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (product names, manufactured by Air Products and Chemicals Inc.); OLFINE B, Y, P, A, STG, SPC, E1004, E1010, PD-001, PD-002W, PD-003, PD-004, PD-005, EXP. 4001, EXP. 4036, EXP. 4051, EXP. 4123, EXP. 4200, EXP. 4300, AF-103, AF-104, AK-02, SK-14, and AE-3 (product names, manufactured by Nissin Chemical Industry Co., Ltd.); and ACETYLENOL E00, E00P, E40, and E100 (product names, manufactured by Kawaken Fine Chemicals Co., Ltd.).

The silicone-based surfactant is not particularly limited, and preferred examples thereof include polysiloxane-based compounds. The polysiloxane-based compound is not particularly limited, and examples thereof include polyether-modified organosiloxane. Examples of a commercially available product of the polyether-modified organosiloxane include BYK-306, BYK-307, BYK-333, BYK-341, BYK-345, BYK-346, and BYK-348 (product names, manufactured by BYK Chemie); KF-351A, KF-352A, KF-353, KF-354L, KF-355A, KF-615A, KF-945, KF-640, KF-642, KF-643, KF-6020, X-22-4515, KF-6004, KF-6011, KF-6012, KF-6015, and KF-6017 (product names, manufactured by Shin-Etsu Chemical Co., Ltd.); and Silface SAG503A (manufactured by Nissin Chemical Co., Ltd.).

As the fluorine-based surfactant, a fluorine-modified polymer is preferably used, and specific examples thereof include BYK-340 (product name, manufactured by BYK Chemie Japan).

Regarding the surfactant, one kind thereof may be used alone, or two or more kinds thereof may be used in combination. Among these, when the surfactant is a silicone-based surfactant, the wettability of the ink adhering surface can be favorably adjusted, and thus the washing fastness and the transferability tend to be more excellent.

A lower limit of a content of the surfactant is preferably 0.05% by mass or more, more preferably 0.10% by mass or more, and still more preferably 0.20% by mass or more with respect to the total amount of the white ink composition.

In addition, an upper limit of the content of the surfactant is preferably 5% by mass or less, more preferably 3% by mass or less, still more preferably 1% by mass or less, and particularly preferably 0.7% by mass or less with respect to the total amount of the white ink composition.

### 1.1.2.6 Other Components

The white ink composition may contain an additive such as a preservative, an antifungal agent, a pH adjuster, a rust inhibitor, a chelating agent, a viscosity adjuster, a solubilizing agent, and an antioxidant as necessary. When such an additive is contained, a content of the additive is not particularly limited, but is preferably 0.1% to 5% by mass, more preferably 0.1% to 3% by mass, and still more preferably 0.1% to 1% by mass with respect to the total amount of the white ink composition.

### 1.1.2.7 Physical Properties

A viscosity of the white ink composition at 25° C. is preferably 2 mPa·s or more and 10 mPa·s or less, and more preferably 3 mPa·s or more and 8 mPa·s or less. As a result, nozzle clogging and the like of the ink jet head are less likely to occur, and ejection stability of the white ink composition is further improved. In addition, clogging recoverability of the nozzle can be further improved.

The viscosity can be obtained by a measurement with a vibration type viscometer, a rotation type viscometer, a capillary type viscometer, or a falling ball type viscometer. For example, with the vibration type viscometer, the viscosity can be obtained by a measurement in accordance with JIS Z 8809.

A surface tension of the white ink composition at 25° C is not particularly limited, but is preferably 20 mN/m or more and 60 mN/m or less, more preferably 25 mN/m or more and 50 mN/m or less, and still more preferably 27 mN/m or more and 40 mN/m or less. As a result, nozzle clogging and the like of the ink jet head are less likely to occur, and ejection stability of the white ink composition is further improved. In addition, clogging recoverability of the nozzle can be further improved.

As the surface tension, it is possible to adopt a value measured by a Wilhelmy method or a ring method. For the measurement of the surface tension, a surface tension meter (for example, DY-300, DY-500, DY-700, and the like, manufactured by Kyowa Interface Science Co., Ltd.) can be used.

### 1.1.3 Glue Ink Composition

The glue ink composition used in the manufacturing method of a transfer medium according to the present embodiment is an ink jet ink composition containing a resin and water. The glue ink composition is a composition used for adhering the image to the fabric, and is not a white ink composition or a non-white ink composition used for coloring.

Hereinafter, each component contained in the glue ink composition will be described.

### 1.1.3.1 Resin

The glue ink composition contains a resin. Description of the resin contained in the glue ink composition is the same as the description of the resin in the white ink composition above.

A glass transition temperature of the resin contained in the glue ink composition is as described above, and is particularly preferably −50 °C or higher and 25 °C or lower. When the glass transition temperature of the resin is within the above-described range, the base material followability (texture) is excellent, but the interface peeling is likely to occur during high-temperature washing, and there is a problem with high-temperature washing fastness. On the other hand, with the manufacturing method of a transfer medium according to the present embodiment, even when the glue ink composition contains the resin having a glass transition temperature within the above-described range, excellent high-temperature washing fastness can be obtained, and thus the base material followability (texture) and the washing fastness can be excellently balanced.

A content of the resin is preferably 1% to 50% by mass, more preferably 3% to 40% by mass, still more preferably 5% to 30% by mass, particularly preferably 8% to 25% by mass, and more particularly preferably 10% to 20% by mass with respect to the total amount of the glue ink composition. When the content of the resin is within the above-described range, there is a tendency that more excellent washing fastness can be obtained.

### 1.1.3.2 Water

The glue ink composition contains water. Description of the water contained in the glue ink composition is the same as the description of the resin in the white ink composition above.

A content of the water is preferably 10% by mass or more, more preferably 30% by mass or more, still more preferably 40% by mass or more, and particularly preferably 50% by mass or more with respect to the total amount of the glue ink composition. The upper limit of the content of the water is not particularly limited, but is, for example, preferably 90% by mass or less, more preferably 80% by mass or less, and still more preferably 70% by mass or less with respect to the total amount of the glue ink composition.

### 1.1.3.3 Organic Solvent

The glue ink composition may contain an organic solvent. Description of the organic solvent contained in the glue ink composition is the same as the description of the resin in the white ink composition above.

A content of the organic solvent is preferably 5% by mass or more and 50% by mass or less, more preferably 7% by mass or more and 40% by mass or less, still more preferably 10% by mass or more and 35% by mass or less, and particularly preferably 12% by mass or more and 20% by mass or less with respect to the total amount of the glue ink composition.

In particular, the total content of the organic solvents contained in the glue ink composition is preferably 20% by mass or less with respect to the total amount of the glue ink composition. In such a case, since the solvent can be sufficiently volatilized without increasing the heating temperature when drying the glue ink composition, there is a tendency that damage to the transfer medium can be reduced.

### 1.1.3.4 Surfactant

The glue ink composition may contain a surfactant. Description of the surfactant contained in the glue ink composition is the same as the description of the resin in the white ink composition above.

A lower limit of a content of the surfactant is preferably 0.05% by mass or more, more preferably 0.10% by mass or more, and still more preferably 0.20% by mass or more with respect to the total amount of the glue ink composition.

In addition, an upper limit of the content of the surfactant is preferably 5% by mass or less, more preferably 3% by mass or less, still more preferably 1% by mass or less, and particularly preferably 0.7% by mass or less with respect to the total amount of the glue ink composition.

### 1.1.3.5 Other omponents

The glue ink composition may contain an additive such as a preservative, an antifungal agent, a pH adjuster, a rust inhibitor, a chelating agent, a viscosity adjuster, a solubilizing agent, and an antioxidant as necessary. When such an additive is contained, a content of the additive is not particularly limited, but is preferably 0.1% to 5% by mass, more preferably 0.1% to 3% by mass, and still more preferably 0.1% to 1% by mass with respect to the total amount of the glue ink composition.

The glue ink composition may contain a color material such as a white color material or a non-white color material, but a content thereof is preferably 0.2% by mass or less, more preferably 0.1% by mass or less, and still more preferably 0.05% by mass or less with respect to the total mass of the glue ink composition; and the lower limit thereof is 0% by mass.

### 1.1.3.6 Physical Properties

A viscosity and a surface tension of the glue ink composition are the same as those of the white ink composition described above.

### 1.2 Non-White Image Forming Step

The manufacturing method of a transfer medium according to the present embodiment may include a step (non-white image forming step) of adhering a non-white ink composition to the base material by an ink jet method to form a non-white image.

### 1.2.1 Aspect of Application

An adhesion amount of the non-white ink composition to the base material in the non-white image forming step is preferably 100 g/m² or less, more preferably 80 g/m² or less, still more preferably 60 g/m² or less, and even more preferably 50 g/m² or less.

In addition, the lower limit of the adhesion amount of the non-white ink composition to the base material in the non-white image forming step is not particularly limited, but is preferably 5 g/m² or more, more preferably 10 g/m² or more, still more preferably 15 g/m² or more, and particularly preferably 20 g/m² or more.

An order of the non-white image forming step is not particularly limited, but is preferably performed before the above-described mixed layer forming step. When the non-white image forming step is performed before the mixed layer forming step, the mixed layer formed by the mixed layer forming step is formed at the base material at which the non-white image has been formed by the non-white image forming step. In general, when the ink layers are formed to be laminated, the interface peeling is likely to occur; but in the manufacturing method of a transfer medium according to the present embodiment, even when the mixed layer is formed at the base material at which the non-white image has been formed, excellent high-temperature washing fastness can be obtained. The mixed layer may be formed at the base material, may be formed at the non-white image, or may be formed at another ink layer formed at the non-white image.

### 1.2.2. Non-White Ink Composition

The non-white ink composition used in the manufacturing method of a transfer medium according to the present embodiment may be an ink jet ink composition containing a non-white color material, a resin, and water.

Hereinafter, each component contained in the non-white ink composition will be described.

### 1.2.2.1 Non-White Color Material

The non-white ink composition contains a non-white color material. Examples of the non-white color material include a pigment and a dye, other than the white color material. As the pigment, for example, an inorganic pigment or an organic pigment can be used.

The inorganic pigment is not particularly limited, and examples thereof include carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite); and white pigments such as iron oxide, titanium oxide, zinc oxide, and silica.

Examples of the carbon black include No. 2300, 900, MCF88, No. 20B, No. 33, No. 40, No. 45, No. 52, MA7, MA8, MA100, and No2200B manufactured by Mitsubishi Chemical Corporation. Examples thereof also include color black FW1, FW2, FW2V, FW18, FW200, S150, S160, and S170, Pretex 35, U, V, and 140U, and special black 6, 5, 4A, 4, and 250 manufactured by Degussa Corporation. Examples thereof also include Conductex SC and Raven 1255, 5750, 5250, 5000, 3500, 1255, and 700 manufactured by Columbia Carbon Company. Examples thereof also include Regal 400R, 330R, and 660R, Mogul L, Monarch 700, 800, 880, 900, 1000, 1100, 1300, and 1400, and Elftex 12 manufactured by Cabot Corporation.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, an azo-based pigment, and the like.

Specific examples of the organic pigment include the following ones.

Examples of the cyan pigment include C.I. Pigment Blue 1, 2, 3, 15: 3, 15: 4, 15: 34, 16, 22, 60, and the like; C.I. Vat Blue 4, 60; and the like, and are preferably a mixture of one or two or more selected from the group consisting of C.I. Pigment Blue 15: 3, 15: 4, and 60.

Examples of the magenta pigment include C.I. Pigment Red 5, 7, 12, 48(Ca), 48(Mn), 57(Ca), 57: 1, 112, 122, 123, 168, 184, 202, C.I. Pigment Violet 19, and the like, and are preferably a mixture of one or two or more selected from the group consisting of C.I. Pigment Red 122,202, and 209, and C.I. Pigment Violet 19.

Examples of the yellow pigment include C. I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include a mixture of one or two or more selected from the group consisting of C. I. Pigment Yellow 74, 109, 110, 128, 138, 150, and 180.

Pigments of other colors can also be used. Examples thereof include an orange pigment, a green pigment, and the like.

The pigment may be used alone or in combination of two or more.

The pigment may be dispersed with a dispersant before use in the same manner as the above-described white color material. The dispersant is as described above, and thus the description thereof will not be repeated.

Although not particularly limited, acid dye, direct dye, reactive dye, and basic dye can be used as the dye. The dye may be used alone or in combination of two or more.

The dye is not particularly limited, but examples thereof include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

A content of the non-white color material is preferably 0.1% to 25% by mass, more preferably 1% to 20% by mass, still more preferably 1% to 15% by mass, particularly preferably 1% to 10% by mass, and more particularly preferably 2% to 7% by mass, with respect to the total amount of the non-white ink composition. When the content of the non-white color material is within the above-described range, color development property tends to be more favorable.

### 1.2.2.2 Resin

The non-white ink composition may contain a resin. Description of the resin contained in the non-white ink composition is the same as the description of the resin in the white ink composition above.

The resin contained in the non-white ink composition is preferably the same resin type as the white ink composition, and more preferably a urethane resin. Since the urethane resin has excellent stretchability, the texture can be favorable by containing the urethane resin in the non-white ink composition for forming an image.

It is particularly preferable that the resin contained in the white ink composition is a urethane resin, the resin contained in the glue ink composition is a polyester resin, and the resin contained in the non-white ink composition is a urethane resin. With the manufacturing method of a transfer medium according to the present embodiment, excellent high-temperature washing fastness can be obtained, the urethane resin is contained in the white ink composition and the non-white ink composition to obtain a favorable texture, and the polyester resin is contained in the glue ink composition to obtain a favorable transferability.

A content of the resin is preferably 0.5% to 25% by mass, more preferably 1% to 20% by mass, still more preferably 1% to 15% by mass, particularly preferably 2% to 10% by mass, and more particularly preferably 2% to 8% by mass with respect to the total amount of the non-white ink composition. When the content of the resin is within the above-described range, there is a tendency that more excellent washing fastness can be obtained.

### 1.2.2.3 Water

The non-white ink composition may contain water. Description of the water contained in the non-white ink composition is the same as the description of the resin in the white ink composition above.

A content of the water is preferably 10% by mass or more, more preferably 30% by mass or more, still more preferably 40% by mass or more, and particularly preferably 50% by mass or more with respect to the total amount of the non-white ink composition. The upper limit of the content of the water is not particularly limited, but is, for example, preferably 90% by mass or less, more preferably 80% by mass or less, and still more preferably 70% by mass or less with respect to the total amount of the non-white ink composition.

### 1.2.2.4 Organic Solvent

The non-white ink composition may contain an organic solvent. Description of the organic solvent contained in the non-white ink composition is the same as the description of the resin in the white ink composition above.

A content of the organic solvent is preferably 5% by mass or more and 50% by mass or less, more preferably 7% by mass or more and 40% by mass or less, still more preferably 10% by mass or more and 35% by mass or less, and particularly preferably 12% by mass or more and 30% by mass or less with respect to the total amount of the non-white ink composition.

In particular, the total content of the organic solvents contained in the non-white ink composition is preferably 30% by mass or less with respect to the total amount of the non-white ink composition. In such a case, since the solvent can be sufficiently volatilized without increasing the heating temperature when drying the non-white ink composition, there is a tendency that damage to the transfer medium can be reduced.

### 1.2.2.5 Surfactant

The non-white ink composition may contain a surfactant. Description of the surfactant contained in the non-white ink composition is the same as the description of the resin in the white ink composition above.

A lower limit of a content of the surfactant is preferably 0.05% by mass or more, more preferably 0.10% by mass or more, and still more preferably 0.20% by mass or more with respect to the total amount of the non-white ink composition.

In addition, an upper limit of the content of the surfactant is preferably 5% by mass or less, more preferably 3% by mass or less, still more preferably 1% by mass or less, and particularly preferably 0.7% by mass or less with respect to the total amount of the non-white ink composition.

### 1.2.2.6 Other Components

The non-white ink composition may contain an additive such as a preservative, an antifungal agent, a pH adjuster, a rust inhibitor, a chelating agent, a viscosity adjuster, a solubilizing agent, and an antioxidant as necessary. When such an additive is contained, a content of the additive is not particularly limited, but is preferably 0.1% to 5% by mass, more preferably 0.1% to 3% by mass, and still more preferably 0.1% to 1% by mass with respect to the total amount of the non-white ink composition.

### 1.2.2.7 Physical Properties

A viscosity and a surface tension of the non-white ink composition are the same as those of the white ink composition described above.

### 1.3 White Image Forming Step

The manufacturing method of a transfer medium according to the present embodiment may include a step (white image forming step) of adhering a white ink composition to the base material by an ink jet method to form a white image.

An adhesion amount of the white ink composition to the base material in the white image forming step is preferably 500 g/m² or less, more preferably 300 g/m² or less, still more preferably 150 g/m² or less, even more preferably 120 g/m² or less, particularly preferably 80 g/m² or less, and more particularly preferably 50 g/m² or less.

In addition, the lower limit of the adhesion amount of the white ink composition to the base material in the white image forming step is not particularly limited, but is preferably 1 g/m² or more, more preferably 4 g/m² or more, still more preferably 10 g/m² or more, particularly preferably 15 g/m² or more, and more particularly preferably 20 g/m² or more.

An order of the white image forming step is not particularly limited, but is preferably performed after the above-described non-white image forming step and before the above-described mixed layer forming step. When the white image forming step is performed after the non-white image forming step and before the mixed layer forming step, the white image can be formed to be laminated on the non-white image, and the mixed layer can be formed to be laminated on the white image. In general, when the ink layers are formed to be laminated, the interface peeling is likely to occur; but in the manufacturing method of a transfer medium according to the present embodiment, even when the mixed layer is formed to be laminated on the white image laminated on the non-white image, excellent high-temperature washing fastness can be obtained.

### 1.4 Glue Ink Layer Forming Step

The manufacturing method of a transfer medium according to the present embodiment may include a step (glue ink layer forming step) of adhering a glue ink composition to the base material by an ink jet method to form a glue ink layer.

An adhesion amount of the glue ink composition to the base material in the glue ink layer forming step is preferably 1,000 g/m² or less, more preferably 400 g/m² or less, still more preferably 250 g/m² or less, even more preferably 150 g/m² or less, particularly preferably 100 g/m² or less, more particularly preferably 70 g/m² or less, and still more particularly preferably 50 g/m² or less.

In addition, the lower limit of the adhesion amount of the glue ink composition to the base material in the glue ink layer forming step is not particularly limited, but is preferably 1 g/m² or more, more preferably 10 g/m² or more, still more preferably 20 g/m² or more, and particularly preferably 30 g/m² or more.

An order of the glue ink layer forming step is not particularly limited, but is preferably performed after the above-described mixed layer forming step. When the glue ink layer forming step is performed after the mixed layer forming step, the glue ink layer can be formed to be laminated on the mixed layer. In general, when the ink layers are formed to be laminated, the interface peeling is likely to occur; but in the manufacturing method of a transfer medium according to the present embodiment, even when the glue ink layer is formed to be laminated on the mixed layer, excellent high-temperature washing fastness can be obtained.

### 1.5 Heating Step

The manufacturing method of a transfer medium according to the present embodiment may include a step (heating step) of heating the base material. By including the heating step, dryability of each ink composition can be improved, and thus color transfer (migration) from the base material caused by insufficient drying of the ink can be reduced.

An order of the heating step is not particularly limited. For example, the heating step may be performed before, after, or simultaneously with the step of forming each of the layers described above.

When the heating step is performed before or simultaneously with the step of forming each of the layers described above (primary heating step), the ink adhered to the base material can be dried at an early stage. The primary drying step is a step for drying at least a part of a solvent component in the ink to an extent that the ink adhered to the base material is at least reduced in the flow of the ink.

The primary heating step can be performed by, for example, a blowing type method based on blowing (warm air) with heating of the base material by a fan or the like, a heat transfer type method based on heating of the base material by an IR heater, a microwave radiation type, a platen heater, or the like, or a method of combining these methods.

A surface temperature of the base material in the primary heating step is preferably 30 °C or higher, more preferably 35 °C or higher, and still more preferably 40 °C or higher. In addition, the upper limit of the surface temperature of the base material in the primary heating step is preferably 60 °C or lower, and more preferably 50 °C or lower.

In particular, the heating step is preferably performed when forming the mixed layer (that is, simultaneously with the mixed layer forming step). When the step of heating the base material is included in the formation of the mixed layer, dryability of the white ink composition and the glue ink composition is improved, and the migration can be reduced even when the amount of the ink adhered to the base material is large.

When the heating step is performed after the step of forming each of the above-described layers (post-heating step), the ink adhered to the transfer medium can be sufficiently dried. The post-heating step is a heating step for sufficiently drying the solvent component of the ink and heating the resins contained in the ink to flatten the coating film of the ink.

The base material in the post-heating step can be heated by an appropriate heating unit when using an ink jet recording device, for example. In addition, the heating can be performed by an appropriate heating unit, not limited to the heating unit provided in the ink jet recording device.

A surface temperature of the base material in the post-heating step is preferably 100 °C or higher, more preferably 120 °C or higher, and still more preferably 150 °C or higher. In addition, the upper limit of the surface temperature of the base material in the post-heating step is preferably 200 °C or lower, and more preferably 180 °C or lower.

### 1.6 Base Material

A shape of the base material used in the manufacturing method of a transfer medium according to the present embodiment is not particularly limited, but a film shape is suitably used. As the film shape, a thickness of the base material is preferably 50 μm or more and 200 μm or less.

The base material preferably has a recording surface that does not absorb or hardly absorbs a liquid such as the ink composition. Here, the recording surface that does not absorb or hardly absorbs a liquid means, quantitatively, that “an amount of water absorption from the start of contact to 30 msec^{1/2} in the BRISTOW method is 10 mL/m² or less”.

Examples of the base material having the recording surface that does not absorb a liquid include films and plates of plastics such as polyvinyl chloride, polyethylene, polypropylene and polyethylene terephthalate (PET); plates of metals such as iron, silver, copper and aluminum, or metal plates or plastic films manufactured by vapor deposition of these various metals; and plates of alloys such as stainless steel, brass. In addition, examples thereof include a base material in which paper or the like is coated with plastics, a base material in which a plastic film is bonded to paper or the like, and a plastic film that does not have an absorption layer (receiving layer). Examples of the plastic include polyvinyl chloride, polyethylene terephthalate, polycarbonate, polystyrene, polyurethane, polyethylene, and polypropylene.

Examples of the base material having the recording surface that hardly absorbs a liquid include a base material in which a coating layer (ink-receiving layer) for receiving the liquid is provided on a surface; and examples thereof include a base material in which a surface of polyvinyl chloride, polyethylene terephthalate, polycarbonate, polystyrene, polyurethane, polyethylene, polypropylene, or the like is coated with the coating layer (ink-receiving layer). The coating layer hardly absorbs the ink, and examples thereof include a layer in which particles such as inorganic compounds are coated with a binder.

Among these, the base material is preferably a film having the ink-receiving layer. By using such a base material, the transferability and the washing fastness tend to be further improved.

In addition, the base material may have a peeling layer that is a layer having a release property. By providing the base material with the peeling layer, the image formed at the transfer medium can be more efficiently transferred, and more excellent washing fastness can also be obtained. Examples of a constituent material of the release layer include a polyethylene wax-based release agent, a silicone-based release agent, and a fluorine-based release agent. The peeling layer can also be used as the ink-receiving layer.

A thickness of the release layer is not particularly limited, but is preferably 5 μm or more and 80 μm or less, and more preferably 10 μm or more and 50 μm or less.

The total adhesion amount of the white ink composition, the glue ink composition, and the non-white ink composition, adhered to the base material as described above, is preferably 550 g/m² or less, more preferably 400 g/m² or less, still more preferably 300 g/m² or less, even more preferably 250 g/m² or less, and particularly preferably 200 g/m² or less. When the adhesion amount is within the above-described range, the migration can be further reduced.

In addition, the lower limit of the total adhesion amount of the white ink composition, the glue ink composition, and the non-white ink composition, adhered to the base material as described above, is not particularly limited, but is preferably 30 g/m² or more, more preferably 50 g/m² or more, still more preferably 80 g/m² or more, and particularly preferably 100 g/m² or more.

The total adhesion amount of the above-described glue ink composition adhered to the base material is preferably 40 g/m² or more, more preferably 60 g/m² or more, and still more preferably 80 g/m² or more. When the adhesion amount is within the above-described range, the washing fastness and the transferability tend to be more excellent.

In addition, the upper limit of the total adhesion amount of the above-described glue ink composition adhered to the base material is not particularly limited, but is preferably 700 g/m² or less, more preferably 500 g/m² or less, still more preferably 300 g/m² or less, particularly preferably 200 g/m² or less, and more particularly preferably 150 g/m² or less.

### 1.7 Recording Device

The ink jet recording device that can be preferably used in the manufacturing method of a transfer medium according to the present embodiment will be described.

As an example of the ink jet recording device, FIG. 1 shows a perspective view of a serial printer. As shown in FIG. 1, a serial printer 20 includes a transport portion 220 and a recording portion 230. The transport portion 220 transports a base material F fed to the serial printer to the recording portion 230, and discharges the base material after recording to the outside of the serial printer. Specifically, the transport portion 220 has each feeding roller, and transports the fed base material F in a transport direction TD.

In addition, the recording portion 230 includes a carriage 234 that is equipped with an ink jet head 231 having a nozzle ejecting the white ink composition, a nozzle ejecting the glue ink composition, and a nozzle ejecting the non-white ink composition to the base material F fed from the transport portion 220, and a carriage moving mechanism 235 that moves the carriage 234 in a scanning direction SD of the base material F.

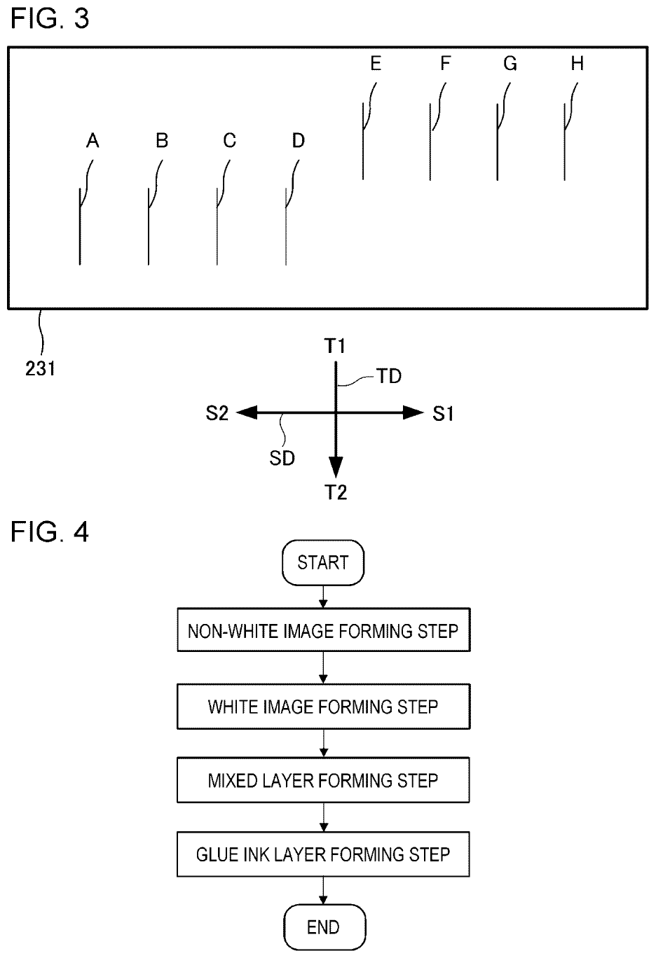

FIG. 3 shows an example of each nozzle array provided on a nozzle surface of the ink jet head 231. In FIG. 3, the ink jet head 231 includes a plurality of nozzle arrays, that is, arrays A to H along the scanning direction SD, each consisting of a plurality of nozzles arranged along a direction (the transport direction TD) intersecting with a direction (the scanning direction SD) in which the ink jet head 231 is moved.

Here, when a nozzle array ejecting the white ink composition is projected along the scanning direction SD, a nozzle array ejecting the glue ink composition is disposed to overlap at least a part of the nozzle array in the transport direction TD, so that the step of adhering the white ink composition and the glue ink composition to the same region of the base material by an ink jet method to form a mixed layer can be performed in the same scanning.

The ink to be ejected from each nozzle array is appropriately selected, but for example, it is preferable to select A to D arrays as the nozzle arrays ejecting the non-white ink composition, E and F arrays as the nozzle arrays ejecting the white ink composition, and G and H as the nozzle arrays ejecting the glue ink composition.

When the serial printer is used, a head having a length less than a width of the base material is provided as the ink jet head 231, and the recording is performed while the head moves in the scanning direction SD intersecting with the transport direction TD of the base material F. In addition, in the serial printer, the head 231 is mounted on the carriage 234 that moves in a predetermined direction, and the head moves in accordance with the movement of the carriage to eject the ink composition onto the base material. The transport of the base material may be performed between the scanning and the scanning.

In addition, the ink jet recording device is not limited to the above-described serial type printer, and may be a line type printer. FIG. 2 shows a schematic side view of a line printer as another example of the ink jet recording device. As shown in FIG. 2, a line printer 1 includes a feeding portion 100, a transport mechanism 200 that transports the base material in the transport direction, a line head 300 that ejects and adheres the ink to the base material, a control unit 500, and a discharge portion 700.

The transport mechanism is a mechanism that transports the base material in the transport direction. In FIG. 2, the roll-shaped base material F is supplied from the feeding portion 100 to the transport mechanism 200, and the transport mechanism 200 is configured to transport the base material F fed from the feeding portion 100 to the line head 300. Specifically, the transport mechanism 200 includes a first feeding roller 201 and a second feeding roller 202, and is configured to transport the fed base material F to the line head 300 downstream in the transport direction. As a transport method of the transport mechanism 200, a known method in the related art can be appropriately used, or one or a plurality of rollers, a belt fed by a roller, or the like may be used.

The line printer 1 includes the line head 300 having a length corresponding to a width of the base material F. The line head 300 may be configured with a plurality of line jets, and in FIG. 2, the line head 300 is configured with a first line head 310, a second line head 320, a third line head 330, a fourth line head 340, and a fifth line head 350. When it is not necessary to distinguish between the first line head 310, the second line head 320, the third line head 330, the fourth line head 340, and the fifth line head 350, the line heads are simply referred to as the line head 300.

The line head 300 has a cavity that accommodates the white ink composition, the glue ink composition, and the non-white ink composition (ink and the like), an ejection driving portion provided for each cavity, and a nozzle ejecting the ink and the like. A plurality of cavities, and a plurality of ejection driving portions and nozzles provided for each cavity may be provided in one head, each independent of the others. The ejection driving portion can be formed using an electromechanical conversion element such as a piezoelectric element that mechanically deforms to change a volume of the cavities, an electronic heat conversion element that emits heat to generate an air bubble in the ink and eject the ink, or the like.

The line head 300 is, for example, preferably configured to eject the white ink composition from the third line head 330 and to eject the glue ink composition from the fourth line head 340. In this manner, the step of adhering the white ink composition and the glue ink composition to the same region of the base material by an ink jet method to form a mixed layer can be preferably performed in the same scanning. In addition, the non-white image forming step, the white image forming step, and the glue ink layer forming step can be performed by ejecting the non-white ink composition from the first line head 310, ejecting the white ink composition from the second line head 320, and ejecting the glue ink composition from the fifth line head 350, which is preferable.

In the line printer, the heads are fixed and do not move (substantially), and the recording is performed in a single scanning of the ink jet heads. The line printer is more advantageous than the serial printer in terms of a high recording speed.

### 2. Transfer Recording Method

The transfer recording method according to the embodiment of the present disclosure includes a step of manufacturing a transfer medium by the above-described manufacturing method, and a step of heating a surface of the transfer medium at which the mixed layer is formed in a state in which the surface faces a fabric to thermally transfer the mixed layer to the fabric.

The transfer recording method according to the present embodiment performs transfer recording by using the transfer medium manufactured by the above-described manufacturing method, and thus can obtain a recorded matter having excellent high-temperature washing fastness.

Hereinafter, each step included in the transfer recording method according to the present embodiment will be described.

### 2.1 Transfer Medium Manufacturing Step

The transfer recording method according to the present embodiment includes a step (transfer medium manufacturing step) of manufacturing a transfer medium by the above-described manufacturing method. The transfer medium manufacturing step is as described above for the manufacturing method of a transfer medium, and thus the description thereof will not be repeated.

### 2.2 Heat Transfer Step

The transfer recording method according to the present embodiment includes a step (heat transfer step) of heating a surface of the transfer medium at which the mixed layer is formed in a state in which the surface faces a fabric to thermally transfer the mixed layer to the fabric.

The image formed at the transfer medium can be transferred to the fabric by performing the heat transfer step. The image to be transferred includes each layer formed in the above-described manufacturing method of a transfer medium, and includes at least the mixed layer.

A heating temperature in the heat transfer step is not particularly limited, but is preferably 120 °C or higher and 270 °C or lower, more preferably 140 °C or higher and 250 °C or lower, and still more preferably 150 °C or higher and 210 °C or lower. When the heating temperature is within the above-described range, there is a tendency that the productivity of the recorded matter can be made more excellent with less energy while suppressing the residual of each layer formed in the above-described manufacturing method of a transfer medium at the base material.

When a glass transition temperature of the resin contained in the glue ink composition is denoted by Tg [°C] and the heating temperature in the heat transfer step is denoted by Tp [°C], it is preferable to satisfy 70≤Tp−Tg≤290, it is more preferable to satisfy 95≤Tp−Tg≤260, and it is still more preferable to satisfy 110≤Tp−Tg≤210. When such a relationship is satisfied, there is a tendency that the productivity of the recorded matter can be made more excellent with less energy while suppressing the residual of each layer formed in the above-described manufacturing method of a transfer medium at the base material.

A heating time in the heat transfer step is not particularly limited, but is preferably 5 seconds or longer and 90 seconds or shorter, more preferably 15 seconds or longer and 70 seconds or shorter, and still more preferably 20 seconds or longer and 60 seconds or shorter.

The heat transfer step may be performed by any method, but is more preferably performed by a heat press when the surface of the transfer medium at which the image including at least the mixed layer is formed faces the fabric.

When the heat transfer step is performed by a heat press, a pressure applied to a laminate of the transfer medium and the fabric is preferably 0.1 N/cm² or more and 30 N/cm² or less, more preferably 0.6 N/cm² or more and 15 N/cm² or less, and still more preferably 1.5 N/cm² or more and 5 N/cm² or less.

The fabric is not particularly limited. A material constituting the fabric is also not particularly limited, and examples thereof include natural fibers such as cotton, linen, wool, and silk, synthetic fibers such as polypropylene, polyester, acetate, triacetate, polyamide, and polyurethane, and biodegradable fibers such as polylactic acid; and the material may be blended fibers thereof. As the fabric, the fibers described above may be in any form such as a woven fabric, a knitted fabric, and a non-woven fabric, and may be mixed fibers.

In the present embodiment, examples of a form of the fabric include cloth, garment, and other clothing ornaments. The cloth includes a woven fabric, a knitted fabric, and a nonwoven fabric. The garment and other clothing ornaments include sewn T-shirts, handkerchiefs, scarves, towels, handbags, and fabric furniture such as bags, curtains, sheets, bedspreads, and wallpaper, cloth before and after cutting as parts to be sewn, and the like. Examples of these forms include a long roll-shaped product, a product cut into a predetermined size, and a product having the shape of a manufactured product.

### 2.3 Washing Step

The transfer recording method according to the present embodiment may include a step (washing step) of washing the fabric with water at a temperature higher than the glass transition temperature of the resin contained in the glue ink composition.

By performing the washing step, the components of the ink composition, which are not fixed to the fabric, can be efficiently washed away, but since the washing is performed with water at a temperature higher than the glass transition temperature of the resin contained in the glue ink composition, there is a problem with high-temperature washing fastness. On the other hand, in the transfer recording method according to the present embodiment, the fabric can be washed while suppressing the interface peeling due to high-temperature washing.

A temperature of the water in the washing step is preferably a temperature higher than the glass transition temperature of the resin contained in the glue ink composition, more preferably a temperature higher than the glass transition temperature of the resin contained in the glue ink composition by 10 °C or higher, still more preferably a temperature higher than the glass transition temperature of the resin contained in the glue ink composition by 20 °C or higher, and particularly preferably a temperature higher than the glass transition temperature of the resin contained in the glue ink composition by 30 °C or higher.

### 2.4 Other Steps

The transfer recording method according to the present embodiment may further include a step of performing heating and drying again after the washing step.

### 3. Example

Hereinafter, the present disclosure will be described in more detail with reference to examples, but the present disclosure is not limited to these examples. Hereinafter, “%” is based on mass unless otherwise specified.

### 3.1 Preparation of Each Ink Composition

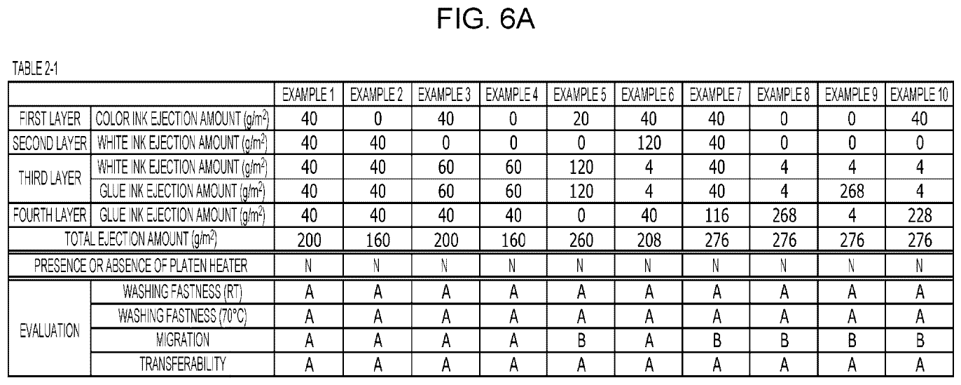

Each component was put into a container to have the formulation shown in Table 1 (shown in FIG. 5), mixed and stirred, and further filtered through a 5 μm membrane filter to obtain each ink composition. It should be noted that “% by mass” of the color material and the resin in the table represents the solid content, and water was added such that the total mass of the composition was 100% by mass. In addition, each color material was used as a dispersion liquid prepared in advance by the following procedure.

As a black pigment, a cyan pigment, a magenta pigment, and a yellow pigment, a pigment dispersion liquid obtained by mixing a pigment with a water-soluble styrene-acrylic resin as a pigment dispersant (not shown in Table 1) in a mass ratio of 1:1 (pigment: pigment dispersant) and sufficiently stirring the mixture in advance was used.

As a white pigment, an anionic resin dispersant was used as the pigment dispersant. Specifically, a styrene-acrylic resin synthesized using 55% by mass of styrene, 20% by mass of acrylic acid, and 30% by mass of methyl methacrylate was used. 1 part by mass of the dispersant and 10 parts by mass of ion-exchanged water were mixed with 3 parts by mass of the white pigment, and the obtained mixture was premixed and then dispersed at a peripheral speed of 10 m/s at a liquid temperature of 30 °C for 15 minutes using zirconia beads having a diameter of 0.03 mm using a bead mill disperser (UAM-015 manufactured by Kotobuki Kogyou Co., Ltd.). Coarse particles were centrifugally separated using a centrifugal separator (Model-3600 manufactured by Kuboyama Shoji Co., Ltd.) to obtain a pigment dispersion liquid.

The description of the contents of Table 1 will be supplemented.

### Non-White Color Material

Black pigment (C.I. Pigment Black 6)
Cyan pigment (C.I. Pigment Blue 15:3)
Magenta pigment (C.I. Pigment Red 122)
Yellow pigment (C.I. Pigment Yellow 74)

### White Color Material

White pigment (C.I. Pigment White 6)

### Resin

Polyurethane resin (TAKELAC W-6110, product name manufactured by Mitsui Chemicals, Inc.)
Polyester resin (PLAS COAT Z-880, product name manufactured by GOO CHEMICAL CO., LTD.; glass transition temperature: −50 °C to 25 °C)

### Surfactant

Silicone-based surfactant (BYK-348, product name manufactured by BYK Chemie)

### 3.2. Production of Transfer Medium

First, a base material (print film for DTF, manufactured by Inkmania Inc.) on which an ink-receiving layer was provided was prepared on a polyethylene terephthalate film.

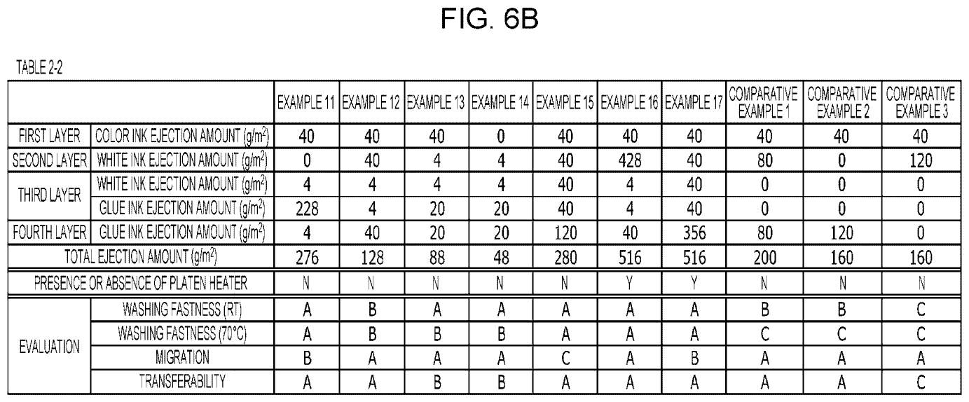

Next, each of the ink compositions obtained as described above was filled in an ink jet recording device (SC-F2150 manufactured by Seiko Epson Corporation), and the ink was ejected from an ink jet head onto the surface of the base material on which the ink-receiving layer was provided, according to the recording conditions shown in Tables 2-1 and 2-2 (shown in FIGS. 6A and 6B), to form each ink layer.

Specifically, as shown in Tables 2-1 and 2-2, the first layer was a color ink layer, the second layer was a white ink layer, the third layer was a mixed layer of the white ink and the glue ink, and the fourth layer was a glue ink layer. Each ink composition was ejected in the order of the first layer to the fourth layer at the ink ejection amount shown in Tables 2-1 and 2-2 such that each layer overlapped. In the description of Tables 2-1 and 2-2, the layer having an ejection amount of 0 g/m² indicates that the ink was not ejected.

In the third layer, the mixed layer was formed by adhering the white ink and the glue ink to the same region of the base material by an ink jet method.

In Examples 16 and 17, the base material surface to which the ink was adhered was heated to 40 °C using a platen heater.

The base material to which the ink had been adhered was dried at 160 °C for 5 minutes to obtain a transfer medium according to each example.

### 3.3 Production of Transferred Object

The surface of the transfer medium obtained as described above, at which the image including at least the third layer (mixed layer) was formed, was heated at 180 °C for 40 seconds in a state of facing a cotton broad (#4000) manufactured by Nisshinbo Co., Ltd., which was a fabric, to thermally transfer the image including the third layer (mixed layer) to the fabric. Thereafter, the base material was removed to obtain a transferred object according to each example.

### 3.4 Evaluation Test

### 3.4.1 Washing Fastness

The transferred object according to each example obtained as described above was washed 10 times in a row at room temperature (RT) or washed 5 times at a water temperature of 70 °C, and evaluated according to the following evaluation criteria.

### Evaluation Criteria

A: no peeling or chipping even after washing 10 times at room temperature or washing 5 times at a water temperature of 70 °C.
B: peeling or chipping occurs after washing once.
C: most of the image is peeled off after washing once.

### 3.4.2 Migration

Occurrence of migration of the transferred object according to each example obtained as described above was visually observed and evaluated according to the following evaluation criteria. The migration refers to color transfer from the base material caused by insufficient drying during intermediate drying of the transfer medium.

### Evaluation Criteria

A: no migration at all
B: slight migration
C: severe migration

### 3.4.3 Transferability

When the transfer medium according to each example obtained as described above was transferred to the fabric, a peeling state of the formed image from the base material was visually checked and evaluated according to the following evaluation criteria.

### Evaluation Criteria

A: image can be transferred without peeling or chipping.
B: slight peeling or chipping occurs.
C: most of the image cannot be transferred.

### 3.5 Evaluation Results

The evaluation results are shown in Tables 2-1 and 2-2.

From the results in Tables 2-1 and 2-2, in each of Examples relating to the manufacturing method of a transfer medium, including the step of adhering the white ink composition and the glue ink composition to the same region of the base material by an ink jet method in the same scanning to form a mixed layer, in which the white ink composition contains a white color material, a resin, and water, the glue ink composition contains a resin and water, and the resin contained in the white ink composition and the resin contained in the glue ink composition are of different resin types, excellent high-temperature washing fastness could be obtained.

On the other hand, in each of Comparative Examples relating to the manufacturing method of a transfer medium that did not satisfy the above-described configuration, at least the high-temperature washing fastness was deteriorated.

The following contents are derived from the above-described embodiments.

An aspect of the manufacturing method of a transfer medium includes adhering a white ink composition and a glue ink composition to the same region of a base material by an ink jet method in the same scanning to form a mixed layer, in which the white ink composition contains a white color material, a resin, and water, the glue ink composition contains a resin and water, and the resin contained in the white ink composition and the resin contained in the glue ink composition are of different resin types.

In one aspect of the above-described manufacturing method of a transfer medium, the resin type may be selected from a urethane resin, a polyester resin, an acrylic resin, an olefin resin, a fluorene resin, a rosin-modified resin, a terpene resin, an amide resin, an epoxy resin, or a vinyl chloride resin.

In any aspect of the above-described manufacturing method of a transfer medium, the resin contained in the white ink composition may be a urethane resin, and the resin contained in the glue ink composition may be a polyester resin.

In any aspect of the above-described manufacturing method of a transfer medium, the manufacturing method may further include adhering the non-white ink composition to the base material by an ink jet method to form a non-white image, in which the mixed layer may be formed at the base material at which the non-white image is formed, and the non-white ink composition may contain a non-white color material, a resin, and water.

In any aspect of the above-described manufacturing method of a transfer medium, the manufacturing method may further include adhering the white ink composition to the base material by an ink jet method to form a white image, in which the white image may be formed to be laminated on the non-white image, and the mixed layer may be formed to be laminated on the white image.

In any aspect of the above-described manufacturing method of a transfer medium, the resin contained in the white ink composition may be a urethane resin, the resin contained in the glue ink composition may be a polyester resin, and the resin contained in the non-white ink composition may be a urethane resin.

In any aspect of the above-described manufacturing method of a transfer medium, the manufacturing method may further include adhering the glue ink composition to the base material by an ink jet method to form a glue ink layer, in which the glue ink layer may be formed to be laminated on the mixed layer.

In any aspect of the above-described manufacturing method of a transfer medium, the base material may be a film having an ink-receiving layer.

In any aspect of the above-described manufacturing method of a transfer medium, the manufacturing method may include heating the base material when forming the mixed layer.

In any aspect of the above-described manufacturing method of a transfer medium, the glass transition temperature of the resin contained in the glue ink composition may be −50 °C or higher and 25 °C or lower.

In any aspect of the above-described manufacturing method of a transfer medium, the total adhesion amount of the white ink composition, the glue ink composition, and the non-white ink composition, adhered to the base material, may be 550 g/m² or less.

In any aspect of the above-described manufacturing method of a transfer medium, the total adhesion amount of the glue ink composition adhered to the base material may be 40 g/m² or more.

An aspect of the transfer recording method includes manufacturing a transfer medium by the above-described manufacturing method, and heating a surface of the transfer medium at which the mixed layer is formed in a state in which the surface faces a fabric to thermally transfer the mixed layer to the fabric.

In one aspect of the above-described transfer recording method, the transfer recording method may further include washing the fabric with water at a temperature higher than the glass transition temperature of the resin contained in the glue ink composition.

The present disclosure is not limited to the above-mentioned embodiment, and various modifications are possible. For example, the present disclosure includes a configuration substantially the same as the configuration described in the embodiment, for example, a configuration having the same function, method, and result, or a configuration having the same object and effect. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

What is claimed is:

1. A manufacturing method of a transfer medium, comprising:
adhering a white ink composition and a glue ink composition to a same region of a base material by an ink jet method in a same scanning to form a mixed layer, wherein
the white ink composition contains a white color material, a resin, and water,
the glue ink composition contains a resin and water, and
the resin contained in the white ink composition and the resin contained in the glue ink composition are of different resin types.

2. The manufacturing method of a transfer medium according to claim 1, wherein
the resin type is selected from a urethane resin, a polyester resin, an acrylic resin, an olefin resin, a fluorene resin, a rosin-modified resin, a terpene resin, an amide resin, an epoxy resin, or a vinyl chloride resin.

3. The manufacturing method of a transfer medium according to claim 1, wherein
the resin contained in the white ink composition is a urethane resin, and
the resin contained in the glue ink composition is a polyester resin.

4. The manufacturing method of a transfer medium according to claim 1, further comprising:
adhering a non-white ink composition to the base material by an ink jet method to form a non-white image, wherein
the mixed layer is formed at the base material at which the non-white image is formed, and
the non-white ink composition contains a non-white color material, a resin, and water.

5. The manufacturing method of a transfer medium according to claim 4, further comprising:
adhering the white ink composition to the base material by an ink jet method to form a white image, wherein
the white image is formed to be laminated on the non-white image, and the mixed layer is formed to be laminated on the white image.

6. The manufacturing method of a transfer medium according to claim 4, wherein
the resin contained in the white ink composition is a urethane resin,
the resin contained in the glue ink composition is a polyester resin, and
the resin contained in the non-white ink composition is a urethane resin.

7. The manufacturing method of a transfer medium according to claim 1, further comprising:
adhering the glue ink composition to the base material by an ink jet method to form a glue ink layer, wherein
the glue ink layer is formed to be laminated on the mixed layer.

8. The manufacturing method of a transfer medium according to claim 1, wherein
the base material is a film having an ink-receiving layer.

9. The manufacturing method of a transfer medium according to claim 1, further comprising:
heating the base material when forming the mixed layer.

10. The manufacturing method of a transfer medium according to claim 1, wherein
a glass transition temperature of the resin contained in the glue ink composition is −50 °C or higher and 25 °C or lower.

11. The manufacturing method of a transfer medium according to claim 4, wherein
a total adhesion amount of the white ink composition, the glue ink composition, and the non-white ink composition, adhered to the base material, is 550 g/m² or less.

12. The manufacturing method of a transfer medium according to claim 1, wherein
a total adhesion amount of the glue ink composition adhered to the base material is 40 g/m² or more.

13. A transfer recording method comprising:
manufacturing a transfer medium by the manufacturing method according to claim 1; and
heating a surface of the transfer medium at which the mixed layer is formed in a state in which the surface faces a fabric to thermally transfer the mixed layer to the fabric.

14. The transfer recording method according to claim 13, further comprising:
washing the fabric with water at a temperature higher than a glass transition temperature of the resin contained in the glue ink composition.
